(19) United States
(12) Patent Application Publication
(10) Pub. No.: US 2006/0085313 A1
(43) Pub. Date: Apr. 20, 2006

(54) Method of making a leveraged charitable donation while increasing net worth

(75) Inventor: John H. Selby, Palm Desert, CA (US)

Correspondence Address: LEYDIG, VOIT & MAYER, LTD.;(SEATTLE OFFICE), TWO PRUDENTIAL PLAZA, SUITE 4900, CHICAGO, IL, 60601-6780, US

(73) Assignee: Social Capital Insurance Services, Inc., Palm Desert, CA (US)

(21) Appl. No.: 11/076,198

(22) Filed: Mar. 9, 2005

Related U.S. Application Data
(60) Provisional application No. 60/632,465, filed on Dec. 2, 2004.
(60) Provisional application No. 60/619,171, filed on Oct. 15, 2004.

(51) Int. Cl. G06Q 40/00

(52) U.S. Cl. 705/35

(57) ABSTRACT

A method of funding a tax-exempt organization. A donor utilizes an original principal sum that is separated into first and second distinct parts. The first part is given as a freely given, separate, and immediate cash donation to a tax-exempt organization. The second part is utilized to purchase an equity-indexed annuity contract, which provides a premium bonus for the initial premium deposit. The corresponding increase in the donor's net worth due to the premium bonus offsets the loss in net worth caused by the cash donation to the tax-exempt organization, resulting in no reduction in the net worth of the donor. At the same time the donor has provided the tax-exempt organization with a cash donation.

### REFERENCE TO RELATED APPLICATION

This patent application claims priority to U.S. provisional Patent Application No. 60/619,171, filed Oct. 15, 2004, and entitled “Method of Making a Leveraged Charitable Donation While Increasing Net Worth,” and 60/632,465, filed Dec. 2, 2004, and entitled “Method of Making a Gift While Increasing Net Worth,” both incorporated herein in their entirety.

### TECHNICAL FIELD OF THE INVENTION

The present invention relates to a method for generating current revenue and endowment funding for tax-exempt organizations, and more specifically to the use of an annuity in conjunction with generating current revenue and endowment funding for a tax-exempt organization.

### BACKGROUND OF THE INVENTION

A tax-exempt organization, such as a non-profit organization or a charity, typically requires a large amount of operating capital to fund its mission and to pay its day-to-day operating expenses. The capital typically comes from donors. Two problems that constantly must be addressed by tax-exempt organizations is how to provide a reliable source of current revenue to sustain the every day activities of the tax-exempt organization, while funding the endowment for future needs, and to do so without depleting funds, programs, and services that the tax-exempt organization provides. If the funds, programs, and services are depleted, it would diminish the tax exempt organization's ability to act in the public interest.

Although the primary source of current revenue and endowment funding for tax-exempt organizations is donors, there is some resistance to making a donation due to the donor's corresponding reduction in net worth. Often, making a donation results in a tax reduction, but even with this tax reduction there is a resulting reduction in the donor's net worth.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a method of funding a tax-exempt organization is provided. A donor utilizes an original principal sum that is separated into first and second distinct parts. The first part is given as a freely given, separate, and immediate cash donation to a tax-exempt organization. The second part is a premium deposit utilized to purchase an equity-indexed annuity.

In an embodiment, the equity-indexed annuity provides a premium bonus for the initial deposit. If the first and second parts of the original principal sum are allocated proportionately, the corresponding increase in net worth caused by the addition of the premium bonus to the donor's equity-indexed annuity offsets the loss in net worth caused by the cash donation to the tax-exempt organization, resulting in no reduction in the net worth of the donor. Moreover, due to the annuity increasing in value by the end of the year from annual gains in the fixed account option, the donor will have a guaranteed increase in net worth by the end of the year should the donor allocate the premium deposit to the fixed account option, even though the donor has provided the tax-exempt organization with a cash donation.

Other features of the invention will become apparent from the following detailed description when taken in conjunction with the drawings, in which:

### BRIEF DESCRIPTION OF THE DRAWINGS

FIG. 1 is a schematic representation of participants in and establishment of a method in accordance with an embodiment of the invention;

FIG. 2 is a schematic representation of making a donation in response to receiving a premium bonus in accordance with an embodiment of the invention;

FIG. 3 is a schematic representation of the disposition of annual gains, from an annuity, in accordance with an embodiment of the present invention;

FIG. 4 is a schematic representation of the donation of a portion of the annuity during the term of the annuity in accordance with an embodiment of the invention;

FIG. 5 is a diagrammatic representation of the disposition of a penalty free withdrawal of the annuity in accordance with an embodiment of the invention; and

FIG. 6 is a diagrammatic representation of the donation of the proceeds of the annuity in accordance with an embodiment of the invention.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Methods of the present invention utilize equity-indexed annuities. Although such annuities are known, a brief description is given here for the benefit of the reader.

An equity-indexed annuity is different from other traditional fixed annuities because of the way it credits interest to the annuity's value. Most traditional fixed annuities only credit interest calculated at a minimum guaranteed fixed rate set in the contract as well as a currently credited, annually declared fixed rate. Once annual interest has been credited, it accrues to principal and the interest gains can never be lost. Equity-indexed annuities, on the other hand, credit interest using the minimum guaranteed fixed rate set in the contract and the annually declared interest rate as a crediting option as well as an interest crediting option using a formula based on changes in the equity index or indices to which the annuity is linked. The formula determines how the additional index-based interest, if any, is calculated and credited. How much interest is received and when the interest is credited depends upon the features of the particular annuity, and is defined in the equity-indexed annuity contract. Like traditional fixed annuities, once interest has been credited, the interest gains accrue to principal and can never be lost.

As previously mentioned, an equity-indexed annuity, like other fixed annuities, also promises to pay a minimum guaranteed interest rate. The interest rate that is paid per year, over the life of the contract, is not less than this minimum guaranteed rate even if the index-linked interest rate is lower.

“Bonused” equity-indexed annuities pay premium bonuses. A premium bonus is a bonus applied to the value of the annuity upon a premium deposit. For example, if an initial deposit of $100,000.00 is deposited into an equity-indexed annuity, and the premium bonus is 10%, then the value of the equity-indexed annuity after the premium bonus is $100,000.00+$10,000.00=$110,000.000.

Bonused equity-indexed annuities are typically deferred annuities that may be converted to an immediate annuity. A deferred annuity is an insurance contract for people who want to save on a tax-deferred basis for many years, and then cash out the annuity with a lump sum payout, or optionally convert their accumulated value in the annuity into an immediate annuity providing an income stream. A deferred annuity's full contract value does not become payable until a specified number of years after purchase or until the death of the owner and/or the annuitant. The owner may take distributions from the annuity at any time during the life of the contract subject to a surrender schedule in the annuity contract. A deferred annuity is most appropriate for individuals who want to save for retirement, find an investment that will earn tax-deferred interest for many years to come, or are simply looking for a more attractive savings rate than that offered by bank certificates of deposit, savings accounts, or money market accounts.

Some bonused equity-indexed annuities are single premium deferred annuities, while others are flexible premium deferred annuities. A bonused single premium deferred annuity or SPDA is an annuity that is purchased with a single premium with a bonus applied to the single premium only. The accumulation of the annuity may be deferred, may be converted into an immediate annuity for an income stream, or periodic payments as well as a partial or full distribution may be made at any time during the life of the contract subject to a surrender schedule in the annuity contract. A bonused single premium deferred annuity is an ideal investment for anyone who wants to let their money grow risk-free while deferring income taxes with the goal of creating income later in life.

A bonused flexible premium deferred annuity (FPDA) is a tax-deferred annuity that accepts unlimited premium payments while the annuity is in an accumulation period. Some allow unlimited premiums to be paid with bonuses applied, only during an initial period such as during the first year or from years one through five, etc. Each, some, or all of the premium deposits may result in a premium bonus being applied. Like the SPDA, a bonused flexible premium deferred annuity is an ideal investment for anyone who wants to let their money grow risk-free while deferring income taxes with the goal of creating income later in life. The accumulation of the annuity may be deferred, may be converted into an immediate annuity for an income stream, or periodic payments as well as a partial or full distribution may be made at any time during the life of the contract subject to a surrender schedule in the annuity contract.

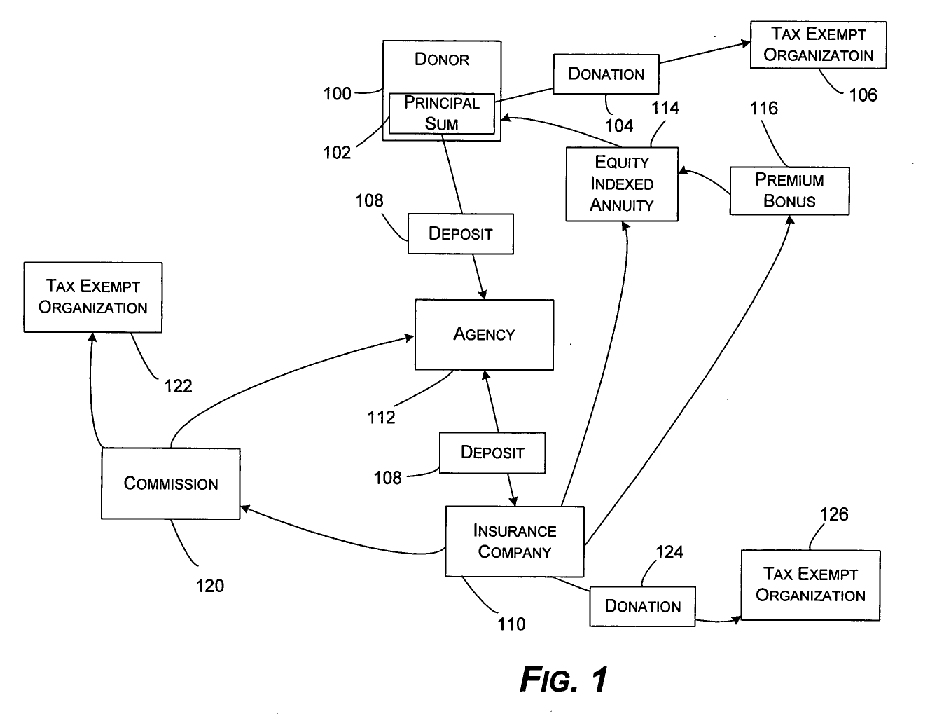

Referring now to the drawings, in which like reference numerals represent like parts throughout the several views, FIG. 1 shows participants in and establishment of a method of making a leveraged charitable donation while increasing net worth in accordance with an embodiment of the invention. In the drawing, a donor 100 having an original principal sum 102 divides the original principal sum into two distinct parts. A first part is given as a donation 104 to a tax-exempt organization 106. A second part is given as a premium deposit 108 to an insurance company 110. The purchase is made through an agency 112. The deposit 108 is used to purchase a bonused equity-indexed annuity 114 that is owned by the donor 100.

In an embodiment, the donation 104 is a freely-given, separate, and immediate cash donation to the tax exempt organization 106. In accordance with an embodiment, the donation 104 meets the requirements of donative intent as established by the Internal Revenue Service.

In accordance with an embodiment, the equity-indexed annuity 114 is a bonused equity-index annuity; that is, a premium bonus 116 is paid for the initial deposit 108. If the bonused equity-indexed annuity 114 is a single premium deferred equity-indexed annuity (SPDA), a single premium bonus 116 is received. If the bonused equity-indexed annuity 114 is a flexible premium deferred equity-indexed annuity (FPDA), there are a number of different options for premium bonuses. For example, the donor may receive a premium bonus 116 on all deposits to the bonused equity-indexed annuity for a limited time period, such as in year one only, or in years one through five, etc. as examples. Alternatively, a fixed, defined number of deposits may receive a premium bonus 116. The terms of the premium bonuses are defined within the bonused equity-indexed annuity contract.

In accordance with an embodiment, the premium bonus 116 paid for the initial premium deposit 108 is equal to or greater than the donation 104. In this manner, by combining the events of the donation 104 and the premium deposit 108, a user can make the donation 104 without a corresponding drop in net worth. As an example, a premium bonus 116 may be 10% of the annuity premium. If the donation 104 is $1,000.00, and the premium deposit 108 $10,000.00, then the original principal sum 102 of the donor 100 was $11,000.00. Thus, due to the increase in value of the annuity by the premium bonus 116 (10% of $10,000.00, or $1,000.00), the immediate value of the annuity after the premium deposit 108 is $11,000.00, which is equal to the original principal sum 102. Thus, the donor 100 has not experienced a drop in net worth.

Moreover, because the bonused equity-indexed annuity 114 pays interest, the value of the bonused equity-indexed annuity will increase over the year if the donor places the premium deposit in the fixed account option. For example, assuming a 3.1% current interest paid by the bonused equity-indexed annuity 114 in the fixed account option, then the appreciation on the $11,000.00 would be at least $341.00 by the end on the first year. This results in an increase in net worth of $341.00 for the year. It can be understood that at higher interest rates, such as those potentially available with the index-linked account options, a larger increase in net worth may be attained.

Moreover, the donor 100 experiences a tax reduction due to the donation 104, which will further increase the benefit to the donor.

Obviously, the deposit 108 and the donation 104 may be adjusted accordingly for the desired effect on net worth. However, in accordance with an embodiment, the premium deposit 108 and the donation 104 are allocated proportionately such that in accordance with the terms of the contract for the bonused equity-indexed annuity 114, the premium bonus 116 is equal to the size of the donation 104.

In accordance with an embodiment, as shown in FIG. 2, the donor 100 may make an additional donation 140 at the time of receiving the initial premium bonus 116 or at the time of receiving an additional premium bonus 128. The additional premium bonus 128 may be received, for example, under a bonused flexible premium deferred equity-indexed annuity that pays a premium bonus for each premium deposit, for example, in years one through five beyond an initial premium deposit.

The additional premium bonus 128 and/or the premium bonus 116 increase the value of the bonused equity-indexed annuity 114. At the time of either of these bonuses being applied, the donor may make a freely given, separate and immediate cash donation 140 (separate from or instead of the donation 104) to the tax-exempt organization 106 or another tax-exempt organization.

If the additional donation 140 is made at the time of the initial premium bonus 116, the net worth of the donor 100 is increased by the addition of the premium bonus 116 and decreased by the amount donated by the additional donation 140. If the initial donation 104 was not made, this donation 140 and the premium bonus 116 may offset one another so that the donor's net worth does not decrease. Alternatively, if the initial donation 104 and the additional donation 140 are both made, the situation posed in FIG. 2 permits two donations 104, 140 to be made, with the net worth of the donor 100 being reduced by both the donations, and being increased by the premium bonus 116. The amount of each of these donations 104, 140 may be selected for the desired effect, for example to not reduce the net worth of the donor 100, or to reduce the net worth only a certain amount (e.g., the amount of the additional donation 140).

For the additional premium bonus 128, the additional donation 140 may be given and not result in a reduction of the net worth of the donor as long as the additional donation is less than or equal to the additional premium bonus 128. Again, the amount of the additional donation 140 may be selected for the desired effect on the net worth of the donor 100.

As an example, the additional donation 140 may equal part or all of the additional premium bonus 128. In addition, in accordance with an embodiment, an additional donation 140 need not be donated each time a premium bonus 128 is received, but may donated some of the time, for example on every other premium bonus. Also, as described above, a premium bonus may not always be paid for premium deposits to a bonused equity-indexed annuity, so the premium bonus may not be relevant to all additional premium deposits.

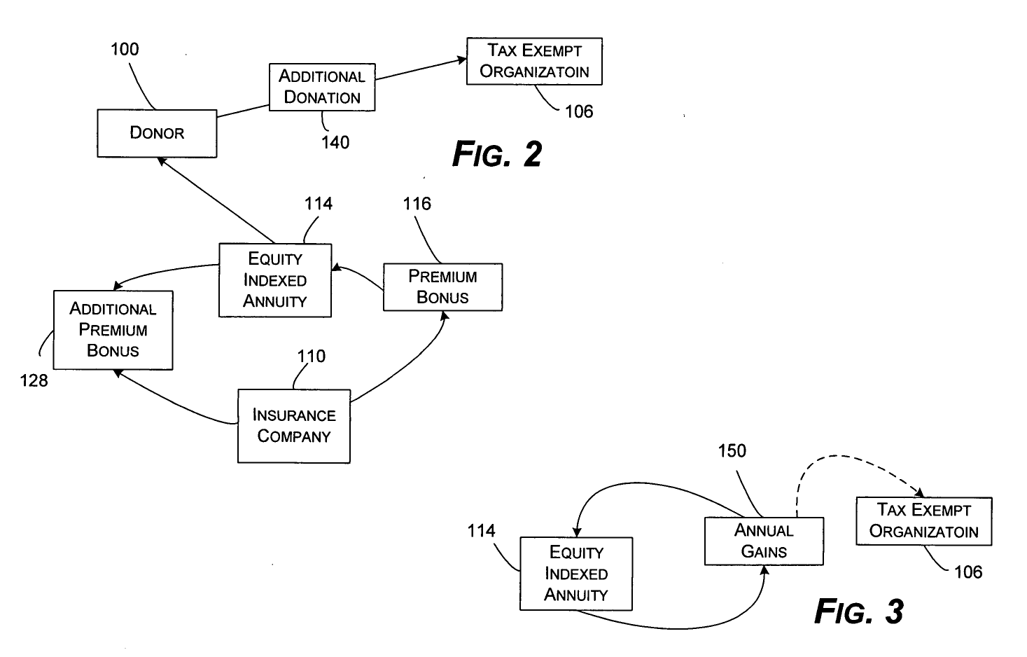

As is known, a bonused equity-indexed annuity, such as the bonused equity-indexed annuity 114, has potential annual gains from interest payments. As shown in FIG. 3, for a deferred bonused equity-indexed annuity, these annual gains are typically reinvested back into the bonused equity-indexed annuity. However, in accordance with an embodiment, some or all of the annual gains 150 may instead be donated by the donor 100 to a tax-exempt organization, such as the tax-exempt organization 106. In year one, this will typically cause surrender penalties. In addition, under most deferred bonused equity-indexed annuity contracts, withdrawing and utilizing some or all of the annual gains 150 during the first year of the term of the annuity causes surrender penalties. However, in accordance with an embodiment, a bonused equity-indexed annuity is structured so that after year one, a portion or all of the annual gains 150 for one or more years is withdrawn without penalties, and the donor 100 may then contribute the amount to a tax-exempt organization 106 without surrender penalties. The contract for the bonused equity-indexed annuity may be structured so that, after the first year, a portion or all annual gains 150 may withdrawn without penalties every year, in every other year, in random years, or as desired. In accordance with an embodiment, a portion or all annual gains 150 are withdrawn, after the first year, and paid to a tax-exempt organization, such as the tax-exempt organization 106, without penalties.

Similarly, as shown in FIG. 4, in accordance with the contract for the bonused equity-indexed annuity, a portion 160 of the principal of the bonused equity-indexed annuity 114 may be paid by the donor 100 to a tax-exempt organization, such as the tax-exempt organization 106. This payment may be made as a withdrawal, with or without penalties, in accordance with the terms of the contract. Moreover, the payment may be made only the first year, only the second year, or at a designated time or times during the term of the contract. If done multiple times, the donation from the portion 160 may be periodic or random.

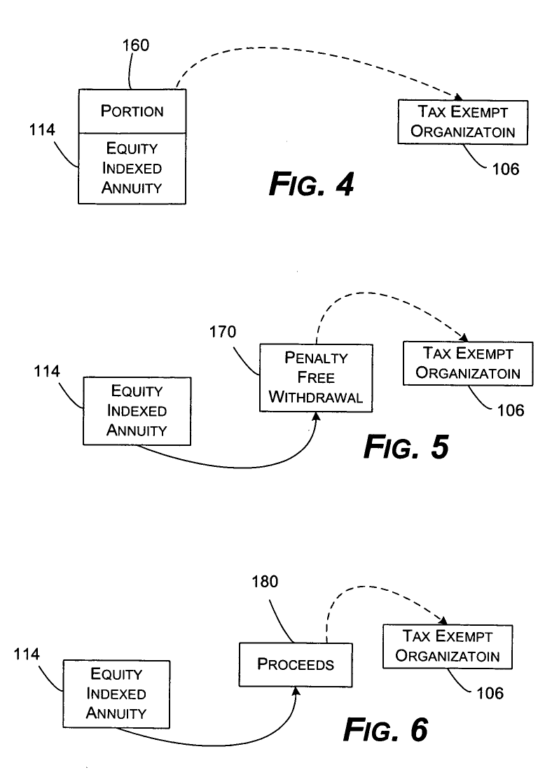

In accordance with another embodiment, the contract for the bonused equity-indexed annuity 114 may be structured such that a penalty free withdrawal 170 (FIG. 5) may be taken during one or more years of the term of the contract, and may be donated to a tax-exempt organization such as the tax-exempt organization 106. The penalty-free withdrawal may be made, for example, only in year two, in random years between years two until the end of the contract, or in a specified year or years.

For each of the scenarios in FIGS. 3-5, the donations to a tax-exempt organization, such as the tax-exempt organization 106, are made by the donor 100 as freely-given, separate, and immediate cash donations. In accordance with an embodiment, the donations meet the requirements of donative intent as established by the Internal Revenue Service. In addition, the amount of the donations to the tax-exempt organization may or may not be equal to the actual withdrawal, portion, or gain. Further, the donations may be made to a different tax-exempt organization than the tax-exempt organization 106.

In accordance with an embodiment, the donor 100 may designate a tax-exempt organization, such as the tax-exempt organization 106, as the sole beneficiary or partial beneficiary of the bonused equity-indexed annuity 114. Thus, as shown in FIG. 6, some or all of the proceeds 180 of the bonused equity-indexed annuity 114 may go to the tax-exempt organization 106 at the end of the term of the contract for the bonused equity-indexed annuity 114 or upon the death of the owner and/or the annuitant. The tax-exempt organization 106 receives the entire annuity value or part of the annuity value, depending upon the beneficiary designation, less any surrender charges, if applicable.

In accordance with an embodiment, as shown in FIG. 1, when the donor 100 makes the premium deposit 108, the insurance company 110 pays a commission 120 to the agency 112. In an embodiment, the contract for the bonused equity-indexed annuity 114 may designate that a specified percentage or amount of the total commissions earned by the agency 112 be paid directly by the insurance company 110 to a tax-exempt organization 122. The specified percentage or amount may or may not include commission bonuses, and may be made on the initial premium and/or additional premiums deposited by the donor 100. The donated portion or amount is paid directly by the insurance company 110 to the tax-exempt organization 122. This tax-exempt organization 122 may be the same or a different organization than the tax-exempt organization 106. The payment of the donation to the tax-exempt organization 122 may be contingent upon the successful expiration of the contract's free look period, or some other milestone.

As an alternative to the insurance company paying the portion of the commissions 120 directly to the tax-exempt organization 122 the agency 112, where permitted by state law, may be required by separate contract to donate directly to the tax-exempt organization 122 an amount or a percentage of the commissions 120.

In accordance with an embodiment, also shown in FIG. 1, the contract for the bonused equity-indexed annuity 114 may dictate that, responsive to the premium deposit 108 by the donor 100, the insurance company 110 is required to donate 124 to a tax-exempt organization, such as the tax-exempt organization 126. This tax-exempt organization 126 may be the same or a different organization than the tax-exempt organization 106. The amount of the donation 124 may be a fixed amount, a percentage of the premium deposit 108, or based on some other formula. The donation 124 may be made following a free look period, and/or may be based upon milestones being reached as defined in the bonused equity-indexed annuity contract.

As can be understood from the foregoing, the method of the present invention provides a manner in which a donor 100 may provide funding for a tax-exempt organization, such as the tax-exempt organization 106, without a corresponding loss of net worth. Moreover, the donor 100 may contribute annual gains, a portion of the bonused equity-indexed annuity's principal, or a penalty free withdrawal from the annuity to a tax-exempt organization, such as the tax-exempt organization 106, during the life of the bonused equity-indexed annuity. Moreover, the contract may be utilized to redirect a portion of commissions that would otherwise go to an agency to a tax-exempt organization, or may require that the insurance company 110 provide a donation 124 to a tax-exempt organization as a result of a premium deposit by a donor or based on some other milestone in the contract. Each of these donations may be to the same tax-exempt organization or to separate tax-exempt organizations designated by the contract or selected by the insurance company and/or the agency.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of funding a tax-exempt organization, comprising:
dividing an original principal sum of a donor into first and second parts;
donating the first part as a freely given, separate, and immediate cash donation to the tax-exempt organization thereby evidencing donative intent; and
using the second part as a premium deposit for purchasing an equity-indexed annuity that provides a premium bonus for the premium deposit.

2. The method of claim 1, further comprising allocating the first and second parts so that the premium bonus is greater than or equal to the first part.

3. The method of claim 1, further comprising allocating the first and second parts so that the premium bonus is equal to the first part.

4. The method of claim 1, wherein the equity-indexed annuity is purchased through an agency, and wherein a contract for the equity-indexed annuity requires a commission donation to a tax-exempt organization from part of commissions to the agency.

5. The method of claim 4, wherein the equity-indexed annuity is issued by an insurance company, and wherein the commission donation is paid directly by the insurance company.

6. The method of claim 1, wherein the equity-indexed annuity is purchased through an agency, and wherein, as a result of the premium deposit, a commission donation is made to a tax-exempt organization from part of commissions to the agency.

7. The method of claim 6, wherein the commission donation is made directly by the agency to the tax-exempt organization under an agency contract that is separate from a contract for the equity-indexed annuity.

8. The method of claim 1, wherein a portion or all of the annual gains for the equity-indexed annuity are donated, by the donor, to a tax-exempt organization.

9. The method of claim 1, wherein a portion or all of annual gains for the equity-indexed annuity are donated, by the donor, to a tax-exempt organization without surrender penalties.

10. The method of claim 1, wherein a portion or all of principal of the equity-indexed annuity is donated, by the donor, to a tax-exempt organization on a periodic basis.

11. The method of claim 1, wherein a portion or all of principal of the equity-indexed annuity is donated, by the donor, to a tax-exempt organization on a periodic basis without surrender penalties.

12. The method of claim 1, wherein a portion or all of principal of the equity-indexed annuity is donated, by the donor, to a tax-exempt organization.

13. The method of claim 1, wherein a portion or all of principal of the equity-indexed annuity is donated, by the donor, to a tax-exempt organization without surrender penalties.

14. The method of claim 1, wherein a contract for the equity-indexed annuity permits a penalty free withdrawal during a term of the equity-indexed annuity, and wherein a portion or all of the penalty free withdrawal is donated, by the donor, to a tax-exempt organization.

15. The method of claim 1, wherein a tax exempt organization is a beneficiary of the equity-indexed annuity.

16. The method of claim 1, further comprising:
depositing an additional premium in the equity-indexed annuity so as to generate an additional premium bonus; and
donating an additional cash donation to a tax-exempt organization, the additional cash donation being less than or equal to the additional premium bonus.

17. The method of claim 15, wherein the additional cash donation is equal to the additional premium bonus.

18. The method of claim 1, wherein the equity-indexed annuity is purchased from an insurance company, and wherein a contract for the equity-indexed annuity requires that the insurance company make a donation to a tax-exempt organization responsive to the purchase.

19. A method of funding a tax-exempt organization, comprising:
dividing an original principal sum of a donor into first and second parts;
donating the first part as a freely given, separate, and immediate cash donation to the tax-exempt organization thereby evidencing donative intent; and
using the second part as a premium deposit for purchasing an equity-indexed annuity that provides a premium bonus for the premium deposit, the second part and the first part being apportioned such that a premium bonus for the premium deposit is equal to the first part.

20. The method of claim 19, further comprising:
depositing an additional premium in the equity-indexed annuity so as to generate an additional premium bonus; and
donating an additional cash donation to a tax-exempt organization, the additional cash donation being less than or equal to the additional premium bonus.

21. The method of claim 20, wherein the additional cash donation is equal to the additional premium bonus.

22. The method of claim 19, wherein the equity-indexed annuity is purchased through an agency, and wherein a contract for the equity-indexed annuity requires a commission donation to a tax-exempt organization from part of commissions to the agency.
